(19) United States
(12) Patent Application Publication
(10) Pub. No.: US 2009/0025752 A1
(43) Pub. Date: Jan. 29, 2009

(54) Device for cleaning rollers

(75) Inventor: Luciano Rui, Soisysous-montmorency (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 10/584,954

(22) PCT Filed: Jan. 6, 2005
(86) PCT No.: PCT/FR2005/050007

§ 371 Date: Oct. 29, 2007

(30) Foreign Application Priority Data
Jan. 7, 2004 (FR) 0400085

(51) Int. Cl. B08B 1/00; C03B 35/16; B08B 1/04; B65G 45/14; B65G 45/18

(52) U.S. Cl. 134/6; 65/168; 15/256.51; 15/256.52; 15/256.53; 198/496; 198/498

(57) ABSTRACT

A device for cleaning a horizontal roll turning about its axis, the device being carried and guided by the roll without following the roll in its rotation, being capable of being displaced by sliding along the roll and cleaning the surface of the roll during its sliding by a cleaning mechanism, for example a cutting tool, fixed to the device. The device allows the cleaning of rolls for conveying glass sheet or glass ribbon, particularly those of a lehr downstream of an installation for forming flat glass such as a float glass installation (formed on a bath of molten metal generally based on tin).

The invention relates to a device for cleaning cylindrical rolls that are liable to become fouled during their operation. More particularly, the invention relates to the cleaning of rolls for conveying glass sheet or glass ribbon, particularly those of a lehr downstream of an installation for forming flat glass, such as float glass (formed on a bath of liquid metal, generally based on a tin).

In a lehr, glass sheet is conveyed by a bed of rolls. Generally, the atmosphere in the lehr is SO₂-enriched so as to produce a sodium sulfate skin on the glass surface, which reduces the likelihood of the glass being marked by the rolls. However, the rolls become progressively fouled by the sulfate, which leads to an increase in roll diameter. The rolls should be cleaned on a regular basis, preferably without the installation having to be shut down. The rolls may be removed individually from the lehr without shutting down operation, but this is a tricky, hazardous operation in terms of equipment and manpower. Another solution has been proposed by U.S. Pat. No. 6,170,293, which describes a movable system that is placed between the rolls and that cleans them using a wire brush. This system makes use of springs so that it can adapt its own geometry to that of the rolls, which may be more or less biased and more or less parallel. The use of such springs in a hot environment (around 600° C. in the case of a lehr) is not recommended. Furthermore, brushing with a wire brush can score the rolls, particularly at such temperatures (600° C.).

According to the invention, use is not made of a device placed between two juxtaposed rolls but a device carried and guided by each roll, independent of the adjacent roll.

The device according to the invention at least partly surrounds the roll to be cleaned and can be displaced parallel to the axis of the roll. It cleans the working length of the roll using a cleaning means fixed to said device.

The device at least partly surrounds the roll in order to be able to be carried by it without falling and in order to be able to slide along the roll. To this end, the device may therefore comprise a kind of slide or collar surrounding the roll without preventing the latter from rotating, in accordance with its principal function. Thus, the invention relates firstly to a device for cleaning a horizontal roll turning about its axis, said device being carried and guided by said roll without following it in its rotation, being capable of being displaced by sliding along the roll and cleaning the surface of said roll during its sliding by means of a cleaning means fixed to said device.

According to one embodiment, in the case in which the rolls to be cleaned are those of a horizontal conveying bed, for example for flat glass, the device only partly surrounds the roll to be cleaned because it must not prevent the conveying of articles on the surface of the roll bed of which it is part (series of aligned, mutually parallel horizontal rolls for forming a conveying bed). In this case, the entire device is in the conveying plane (plane of contact between a conveyed flat article and the rolls).

The device may, in particular, comprise two contact surfaces or blocks resting on the (“carrier”) roll, which are connected together in a fixed manner by a piece passing under the roll, said device being equipped with a cleaning system and capable of sliding parallel to the axis of the roll so as to clean its entire working length. According to the invention, the device may comprise two surfaces contacting with the upper face of the roll, said surfaces being connected together via a link passing under said roll, said surfaces serving both for carrying the device and for sliding over the roll.

The device according to the invention cleans the roll while the latter is turning in order to carry out its function (in particular, the conveying of flat glass). The device according to the invention does not turn and is not entrained by the roll. In order to prevent it being entrained by the rotation of the roll, it is possible, in particular, to envisage at least one of the following solutions:
making the device sufficiently heavy and/or giving it a center of gravity sufficiently below the roll;
providing a stop connected to the device by an arm passing under an adjacent roll so that the stop comes into contact with said adjacent roll in case the device has a tendency to be entrained in rotation by the roll. The stop may be a block;
providing a rail or a rod passing under the roll to be cleaned, and parallel to this roll, and also guiding the device in its movement sliding along the roll. The device then has two parallel guides for its displacement along the roll—the roll itself and this rail or this rod.

Thus, according to one embodiment, the device comprises an arm passing under a roll adjacent to that to be cleaned, said arm carrying a stop that is able to come into contact with said adjacent roll in order to prevent the entrainment in rotation of the device by the roll to be cleaned.

The cleaning means carried by the device may be a cutting tool. This cutting tool may, in particular, be carried by one of the two blocks acting as a surface contacting with the roll to be cleaned. This cutting tool is placed on the device on the side to be cleaned, i.e. when it is placed at one of the end of the roll that is not yet cleaned, opposite the other end. The cutting tool fulfills its function during sliding of the device along the roll to be cleaned. The cutting tool may, in particular, comprise a series of juxtaposed teeth in order to cut in the manner of a knife or of a toothed saw.

As roll-cleaning means, use may also be made of a wire brush driven in rotation by a motor carried by the device according to the invention.

The device is displaced along the roll in order to clean its working surface. This displacement may be actuated, for example, by a rod fixed to it via one end, said rod being parallel to the roll to be cleaned, it being possible for the other end to be manipulated—by an operator for example—in order to impart to the device its translational movement along the roll.

The invention also relates to the use of the device according to the invention for cleaning rolls for conveying articles, in particular slabs. The rolls may also convey a ribbon, such as a continuous glass ribbon emerging from a float installation. These articles (in particular, slabs) may be of any kind, particularly of glass, particularly of flat glass. In order to convey, the rolls are juxtaposed in parallel in a plane in a The use according to the invention may take place particularly in a lehr, particularly for removing sodium sulfate deposits that foul the rolls. The invention allows cleaning of the rolls during their operation without it being necessary either to remove them or to stop them.

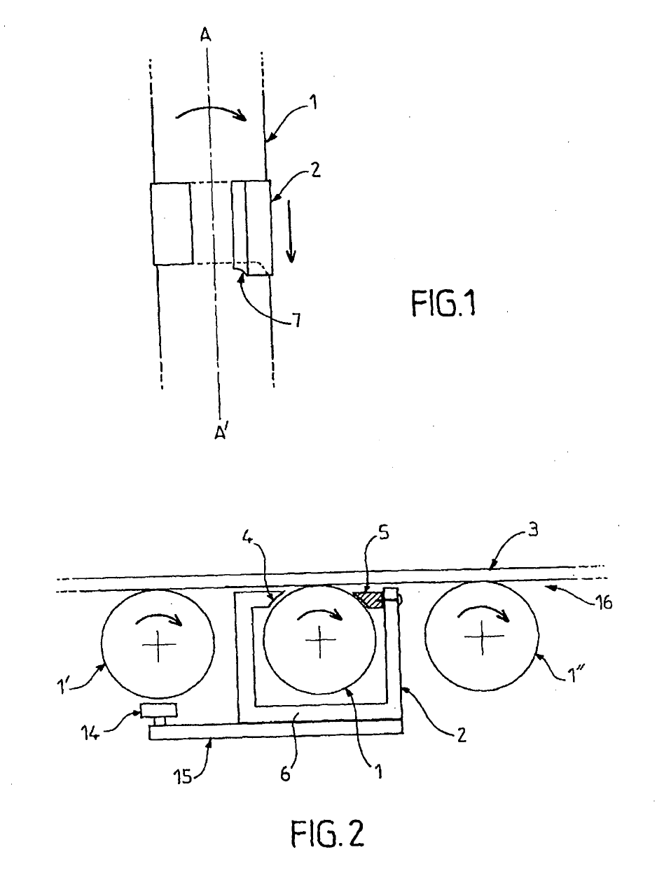

FIG. 1 shows (plan view) a roll 1 driven in rotation on its axis A-A′, carrying a device 2 according to the invention. FIG. 2 shows a set of three juxtaposed rolls 1, 1′, 1″ conveying a glass ribbon 3, the roll 1 carrying the device according to the invention. This device comprises two surfaces (blocks 4 and 5) contacting with the upper face of the roll and resting on the roll via these surfaces, without being entrained by its rotation. These two blocks are connected together by the linking piece 6 that passes under the roll. The block 5 is equipped with a cutting tool 7. By sliding along the roll 1, the device 2 displaces the cutting tool 7, which removes undesirable deposits from the roll. The device may be displaced along the roll by an operator using a rod fixed to the device and parallel to the roll under it. The cutting tool is preferably made from a material that is much harder than the roll, for example from tungsten carbide.

In order to prevent the device 2 being entrained in rotation by the carrier roll, it is possible to make provision for the linking piece 6 to be extended by an arm 15 as far as underneath an adjacent roll (the upstream roll relative to the glass-ribbon conveying direction) so that one block 14 carried by said arm 15 comes into contact with said adjacent roll 1′ in the event of a slight rotation, in order to prevent the progression of this rotation. This figure clearly shows that the device is fully under the conveying plane 16. Therefore, it does not interfere with the conveying of the flat glass 3.

The cutting tool may comprise a series of juxtaposed teeth 13, as shown in FIG. 5.

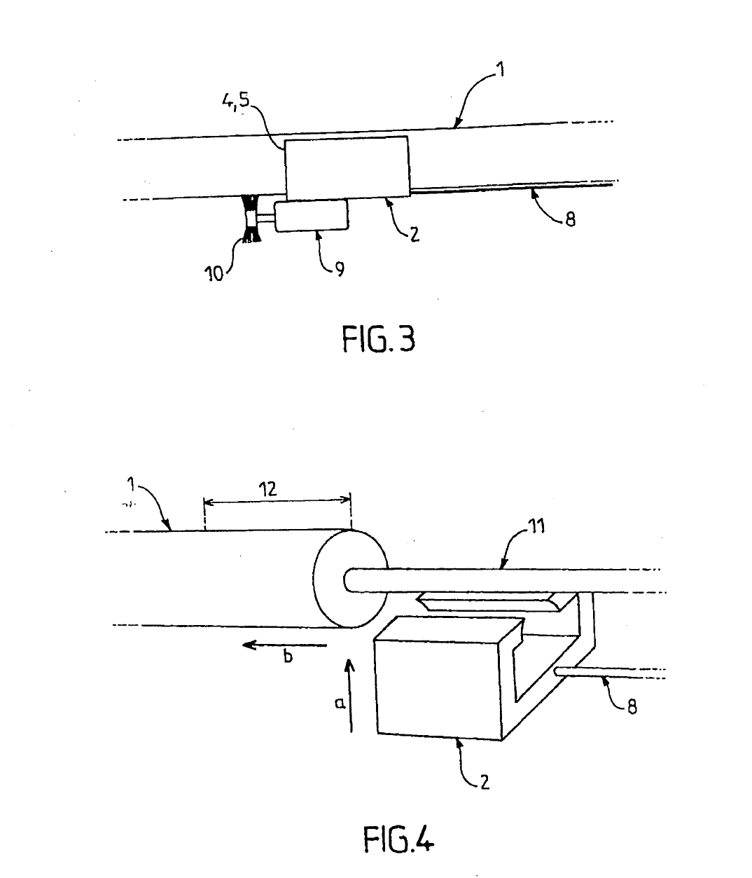

It is also possible to replace the cutting tool with a wire brush driven in rotation by a motor. FIG. 3 shows one such device. In this case, the blocks 4 and 5 both have the function of sliding over the roll (and not, in the case of one of them, of cutting off deposits). A motor 9 is fixed under the device 2, i.e. practically at the level of the piece 6 acting as the link between the two blocks. This motor turns a wire brush 10, cleaning the roll 1. The rod 8 serves for displacing the device over the entire working length of the roll. The motor may, in particular, be of the pneumatic type, i.e. driven in rotation by a flow of pressurized air. This air, after being passed into the motor in order to drive it, may be expelled at the level of the brush and thus act additionally as cooling fluid.

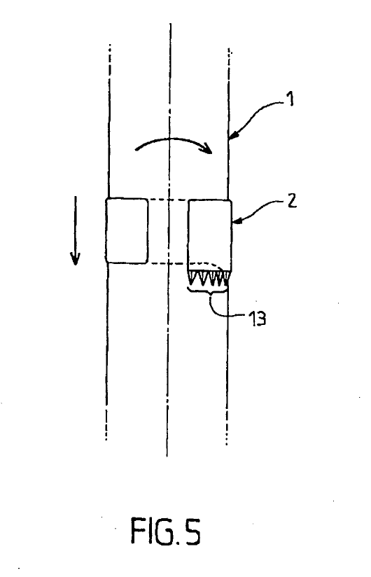

The device according to the invention may be mounted on the roll to be cleaned at any time during operation. If the rolls have smaller diameters at their ends than in their central part (in the case of lehr conveyor roll “journals”), it suffices to make provision for a space between the two blocks (4, 5), on the one hand larger than the diameter of these ends and on the other smaller, of course, than the diameter of the roll in its central part. FIG. 4 shows a conveying roll 1 that comprises, at one end, a part 11 of smaller diameter. The device 2 is presented under the journal 11, the device is mounted around the journal (movement of the arrow (a)), and it is placed at the end of the part with largest diameter, in the zone 12 (movement of the arrow (b)) . This zone 12 will not be cleaned, but in fact this is unnecessary since this is a non-working zone during operation, i.e. it does not receive the glass and thus does not become fouled. In the case of a lehr, the journals pass through the walls of the lehr in order to rest on rolling bearings outside the lehr. Movable parts of walls generally allow access to the journals. It thus suffices to remove these movable walls under the journals in order to position the device according to the invention. The rod 8 allows the device to be actuated from outside the lehr. By way of example, the journals may have a diameter of 200 mm and the central part of the rolls a diameter of 305 mm.

Provision may be made for a suction hose fixed on the device 2, reaching as far as the location where the deposits are removed, in order to recover them. This hose emerges from the lehr following the path of the rod 8.

The device according to the invention may also be used to clean rolls for sizing glass fibers. These rolls dip into a fairly sticky sizing liquid and, over time, become laden with deposits from this liquid.

As appropriate, instead of mounting a cutting tool on one of the blocks, it is possible to equip it with a polishing system that rubs the metal of the roll without scoring it (operation also known as “burnishing”).

1-21. (canceled)

22. A device for cleaning a roll, comprising:
roll-cleaning means; and
two surfaces contacting an upper face of the roll to be cleaned when the roll is horizontal, the surfaces being connected together via a link passing under the roll when the roll is horizontal, the surfaces serving both for carrying the cleaning device and for sliding over the roll to be cleaned.

23. The device as claimed in claim 22, further comprising an arm passing under a roll adjacent the roll to be cleaned, the arm carrying a stop configured to come into contact with the adjacent roll.

24. The device as claimed in claim 22, wherein the roll-cleaning means includes a cutting tool.

25. The device as claimed in claim 24, wherein the cutting tool is carried by a block acting as a surface contacting with the roll to be cleaned.

26. The device as claimed in claim 22, wherein the roll-cleaning means including a wire brush driven in rotation by a motor.

27. A roll cleaned by the device of claim 22.

28. An assembly comprising:
a horizontal roll rotating about its axis; and
a cleaning device surrounding the roll at least partially and configured to slide over the roll, the cleaning device being carried exclusively by the roll, the cleaning device comprising means for cleaning the roll and means for preventing following the roll in its rotation.

29. The assembly as claimed in claim 28, wherein the cleaning device further comprises:
two surfaces contacting an upper face of the roll to be cleaned when the roll is horizontal, the surfaces serving both for carrying the cleaning device and for sliding over the roll to be cleaned.

30. A method for cleaning a horizontal roll about its axis by a cleaning device configured to be displaced along the roll by sliding and that cleans the surface of the roll in the course of its sliding by a cleaning means fastened to the cleaning device, wherein the cleaning device is carried and guided by the roll independently of another roll and includes means for preventing following the roll in its rotation.

31. The method as claimed in claim 30, wherein the cleaning device includes two surfaces contacting an upper face of the roll to be cleaned, the surface being connected together via a link passing under the roll, the surfaces serving both for carrying the cleaning device and for sliding over the roll to be cleaned.

32. The method as claimed in claim 30, wherein the cleaning device includes an arm passing under a roll adjacent that to be cleaned, the arm carrying a stop configured to come into contact with the adjacent roll to prevent entrainment in rotation of the cleaning device by the roll to be cleaned.

33. The method as claimed in claim 30, wherein the cleaning means includes a cutting tool.

34. The method as claimed in claim 30, wherein the cutting tool is carried by a block acting as a surface contacting with the roll to be cleaned.

35. The method as claimed in claim 30, wherein the cleaning means includes a wire brush driven in rotation by a motor.

36. The method as claimed in claim 30, wherein the roll is a conveyor roll.

37. The method as claimed in claim 30, wherein the roll conveys plates.

38. The method as claimed in claim 30, wherein the roll conveys glass.

39. The method as claimed in claim 30, wherein the roll conveys plates or a strip.

40. The method as claimed in claim 30, wherein the conveying roll is that of a tunnel furnace.

41. The method as claimed in claim 30, wherein the roll is cleaned during a glass-conveying operation.

42. The method as claimed in claim 30, wherein the cleaning device removes a sodium-sulfate deposit.
